(19) United States
(12) Patent Application Publication
(10) Pub. No.: US 2008/0208699 A1
(43) Pub. Date: Aug. 28, 2008

(54) SALES-ASSISTANCE PROCESSING METHOD, APPARATUS, AND COMPUTER-READABLE MEDIUM

(75) Inventor: Shinya TSUNASAWA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/869,119

(22) Filed: Oct. 9, 2007

(30) Foreign Application Priority Data
Feb. 28, 2007 (JP) 2007-050264

(51) Int. Cl. G06Q 30/00

(52) U.S. Cl. 705/21

(57) ABSTRACT

A method, system, and computer-readable medium of sales assistance include transmitting between a first sales site and a server a first message indicating that a product is unavailable at the first sales site. The method, system, and computer-readable medium also include determining and transmitting, between the server and the first sales site, a second message indicating a location of a second sales site at which the product is available, and displaying the location at the first sales site.

### BACKGROUND

1. Field

One or more embodiments of the present invention relate to sales-assistance processing techniques, and, more particularly to techniques assisting sales of sold-out products.

2. Description of the Related Art

By way of example, Japanese Unexamined Patent Application Publication No. 2004-326469 discusses a vending-machine management system that can be implemented at a low cost, that allows efficient management of a plurality of vending machines at a low operation cost, and that provides improved service to users of the vending machines. More specifically, when it is not possible to sell a product at a vending machine, the vending machine generates and displays a code in which vending machine information including the cause of the situation is encoded. A user who was not able to purchase a product that the user selected reads an image of the code using a cellular phone and sends the image to a management server. Then, the management server decodes the code received to obtain the vending machine information, and updates vending-machine management information stored therein on the basis of the vending machine information obtained. Further, the management server sends specific information for convenience of the user to the cellular phone, such as a schedule of supply of the product at the vending machine, or location information of nearby vending machines. The publication only discusses that such information is provided.

As another example, Japanese Unexamined Patent Application Publication No. 2005-128645 discusses a privilege assignment system in which a privilege can be assigned to a portable terminal from which location information is provided, such as a cellular phone. More specifically, a distance of movement is calculated on the basis of the location information obtained, and a discount rate is calculated on the basis of the distance of movement. Furthermore, the number of pieces of data is calculated on the basis of the location information, and a discount rate is calculated on the basis of the number of pieces of data. These discount rates are added up, and the total discount rate is applied to call charges charged on the owner of the portable terminal from which the location information has been provided. However, the techniques do not relate to sales of products.

The techniques discussed in the first publication described above only present information to the user, and might not lead to actual purchases. That is, if the user considers it laborious to buy the product with reference to the information presented to the user, the user can choose to buy another product. Thus, the information is only effective for consumers who really wish to buy the product. As for the techniques disclosed in the second publication, although it is disclosed that a privilege corresponding to a distance of movement is assigned, this does not lead to purchase of a product.

### SUMMARY

One or more embodiments of the present invention include a sales-assistance processing method including the operations of receiving a sales-site query request and storing the sales-site query request in a storage device, the sales-site query request including a product code of a sold-out product, a code of a sales site where the sold-out product became sold out, and member identification information, and the sales-site query request being transmitted from a terminal at the sales site where the sold-out product became sold out; searching a stock-data storage unit storing codes of sales sites and product stock data using the product code of the sold-out product, and searching a sales-site-data storage unit storing codes and location data of sales sites using the product code of the sold-out product, thereby extracting location data and codes of sales sites located within a predetermined range of the sales site where the sold-out product became sold out and having stocks of the sold-out product; extracting map data for indicating locations of the sales sites corresponding to the extracted codes from a map-data storage unit storing map data, updating the map data so that the map data indicates the locations of the sales sites corresponding to the extracted codes and includes the extracted codes of the sales sites, and sending the updated map data to the terminal at the sales site where the sold-out product became sold out; receiving the code of a sales site selected from the sales sites corresponding to the extracted codes by a user from the terminal at the sales site where the sold-out product became sold out; and storing the member identification information, the code of the sales site selected by the user, the product code of the sold-out product, and a point value in a point-calculation-data storage unit.

To achieve the above and/or other aspects and advantages, embodiments of the present invention include a method, system, and computer-readable medium of sales assistance include transmitting between a first sales site and a server a first message indicating that a product is unavailable at the first sales site. The method, system, and computer-readable medium also include determining and transmitting, between the server and the first sales site, a second message indicating a location of a second sales site at which the product is available, and displaying the location at the first sales site.

Additional aspects and/or advantages will be set forth in part in the description which follows and, in part, will be apparent from the description, or may be learned by practice of the invention.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram showing an overview of a system used in present embodiments.

FIG. 2 is a functional block diagram of a vending machine used in the present embodiments.

FIG. 3 is a diagram showing an example of data stored in a stock table.

FIG. 4 is a diagram showing an example of data stored in a vending machine DB.

FIG. 5 is a diagram showing an example of data stored in a member DB.

FIG. 6 is a diagram showing an example of data stored in a map DB.

FIG. 7 is a diagram showing an example of data stored in a point calculation table.

FIG. 8 is a flowchart of a first process executed in a first embodiment.

FIG. 9 is a flowchart of a point calculating process executed in the first embodiment.

FIG. 10 is an illustration showing an example of data displayed on a display of a vending machine.

FIG. 11 is a flowchart of a second process executed in the first embodiment.

FIG. 12 is a diagram showing an example of data stored in a point calculation DB in the first embodiment.

FIG. 13 is an illustration showing an example of data displayed on a display of a vending machine.

FIG. 14 is an illustration showing an example of data displayed on a display of a user terminal.

FIG. 15 is a flowchart of a third process executed in the first embodiment.

FIG. 16 is a flowchart of a first process executed in a second embodiment.

FIG. 17 is an illustration of data showing an example of data displayed on a display of a vending machine.

FIG. 18 is an illustration of data showing an example of data displayed on a display of a vending machine.

FIG. 19 is a flowchart of a second process executed in the second embodiment.

FIG. 20 is a flowchart of a second point calculating process executed in the second embodiment.

FIG. 21 is an illustration showing an example of data displayed on a display of a vending machine.

FIG. 22 is a diagram showing an example of data stored in a point calculation DB in the second embodiment.

FIG. 23 is an illustration showing an example of data displayed on a display of a vending machine.

FIG. 24 is an illustration showing an example of data displayed on a display of a user terminal.

FIG. 25 is a flowchart of a third process executed in the second embodiment.

FIG. 26 is a flowchart of a fourth process executed in the second embodiment.

FIG. 27 is an illustration showing an example of data displayed on a display of a user terminal.

FIG. 28 is a flowchart of a fifth process executed in the second embodiment.

FIG. 29 is a functional block diagram of a computer.

### DESCRIPTION OF THE EMBODIMENTS

Reference will now be made in detail to embodiments, examples of which are illustrated in the accompanying drawings, wherein like reference numerals refer to the like elements throughout. Embodiments are described below to explain the present invention by referring to the figures.

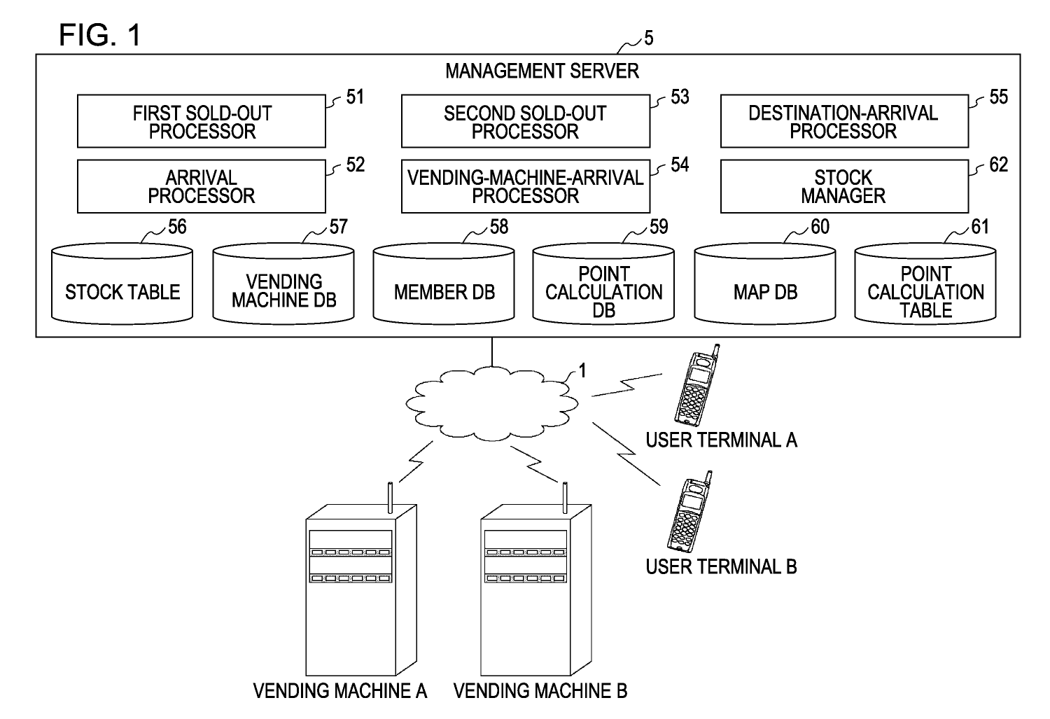

FIG. 1 shows an overview of a system used in the present embodiments. Referring to FIG. 1, a plurality of vending machines (vending machines A and B in FIG. 1), a plurality of user terminals (user terminals A and B in FIG. 1) operated by users, and a management server 5, which executes main processes in the embodiments, are each connected to a network 1, such as the Internet, a cellular phone network, or the public switched telephone network. The user terminals A and B in FIG. 1 can be cellular phones, personal handy phones systems, or other terminals operated by users.

Each of the user terminals includes a mailer function, and a function executing application programs, such as applets. In a first embodiment, however, it may suffice for a user terminal to include only a mailer function, or to include a Web browser function in addition to a mailer function. In a second embodiment, each of the user terminals also includes a GPS (Global Positioning System) function, in addition to the mailer function and/or the Web browser function.

The management server 5 includes a first sold-out processor 51, an arrival processor 52, a second sold-out processor 53, a vending-machine arrival processor 54, a destination arrival processor 55, a stock table 56, a vending machine database (DB) 57, a member data base (DB) 58, a point calculation data base (DB) 59, a map data base (DB) 60, a point calculation table 61, and a stock manager 62. The first sold-out processor 51 and the arrival processor 52 are used in the first embodiment, and the second sold-out processor 53, the vending-machine arrival processor 54, and the destination arrival processor 55 are used in the second embodiment.

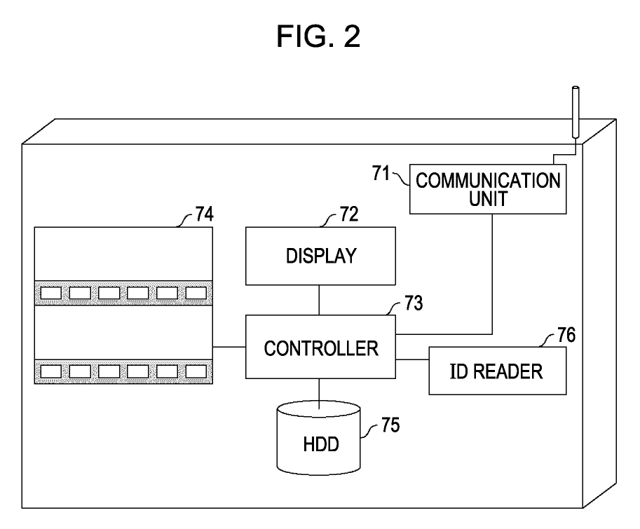

FIG. 2 is a functional block diagram of a vending machine used in the present embodiments. A vending machine used in the present embodiments is also referred to as a sales site terminal. The vending machine includes a touch-panel display 72, such as a liquid crystal display, a communication unit 71 that is connected to the network 1 in a wired manner or wireless manner, an ID reader 76 that reads a member ID from a member card, a hard disk drive (HDD) 75 that stores data, programs, and so forth which may be used for processing, a basic sales function unit 74 having buttons for selecting sales products, basic functions for product sales, and so forth, and a controller 73 that controls the entire vending machine.

The member card may be, for example, an IC card or a magnetic card. The ID reader 76 may be a reader for magnetic cards, a reader for contact IC cards, or a reader for contactless IC cards. Depending on particular applications, the ID reader 76 may be omitted, and a member ID may be input via the touch-panel display 72.

The controller 73 receives sales data of individual products from the basic sales function unit 74, and sends (or transmits) data regarding the presence or absence of stocks of the individual products to the management server 5 via the network 1 as may be needed. Upon receiving the stock data from the vending machine via the network 1, the stock manager 62 of the management server 5 updates the stock table 56 based upon the stock data received.

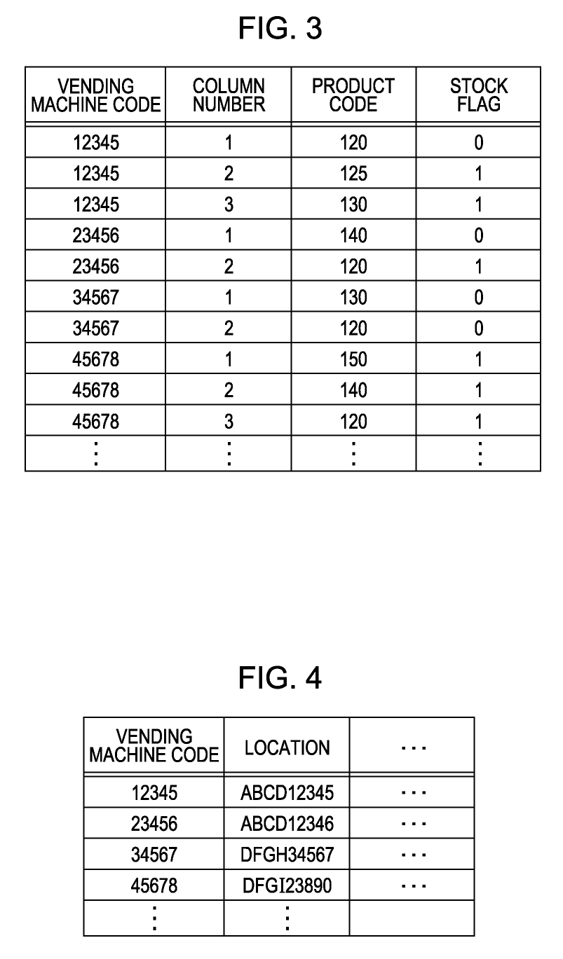

FIG. 3 shows an example of data stored in the stock table 56. In the example shown in FIG. 3, the data includes vending machine codes, column numbers (No.) representing numbers of stock places or the like of the vending machine, product codes, and/or stock flags (“1” indicating stocks available, and “0” indicating out of stock).

FIG. 4 shows an example of data stored in the vending machine DB 57. In the example shown in FIG. 4, the data includes vending machine codes and/or locations (latitudes and longitudes, predetermined address codes, or the like).

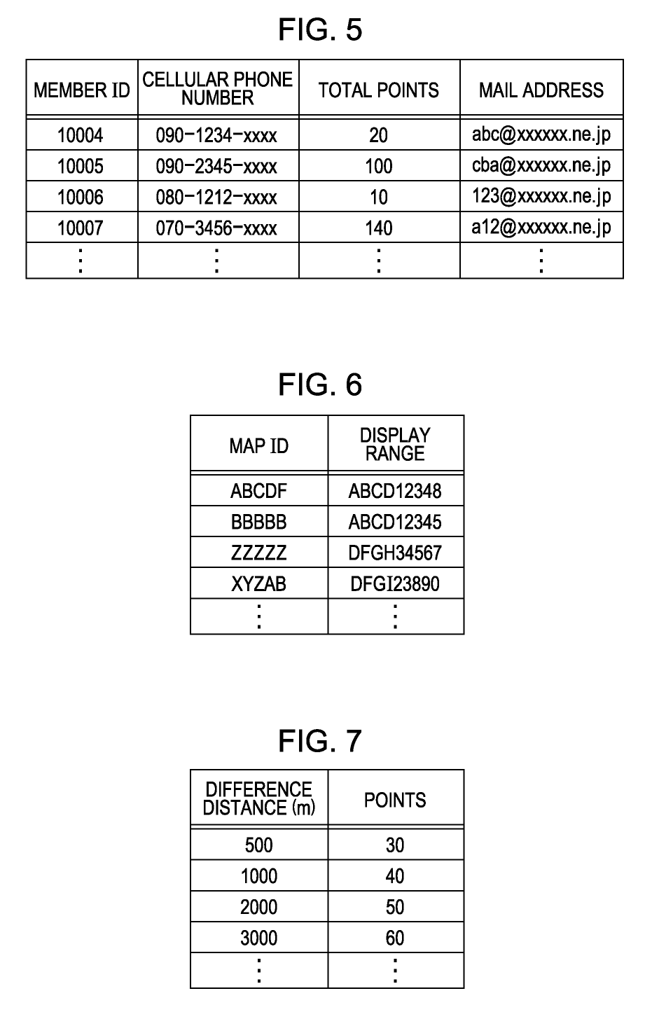

FIG. 5 shows an example of data stored in the member DB 58. In the example shown in FIG. 5, the data includes member IDs, cellular phone numbers, total point values, and/or mail addresses used with cellular phones or the like. Before using the service of the system shown in FIG. 1, a user executes a procedure registering data in the member DB 58.

FIG. 6 shows an example of data stored in the map DB 60. In the example shown in FIG. 6, map IDs, and/or data representing display ranges of the maps are registered. Further, in the map DB 60, map data corresponding to the map IDs is stored.

FIG. 7 shows an example of data stored in the point calculation table 61. In the example shown in FIG. 7, ranges of difference distance and/or corresponding point values are registered. For example, a distance up to 500 m corresponds to 30 points, and a distance in a range of 501 m to 1,000 m corresponds to 40 points.

### First Embodiment

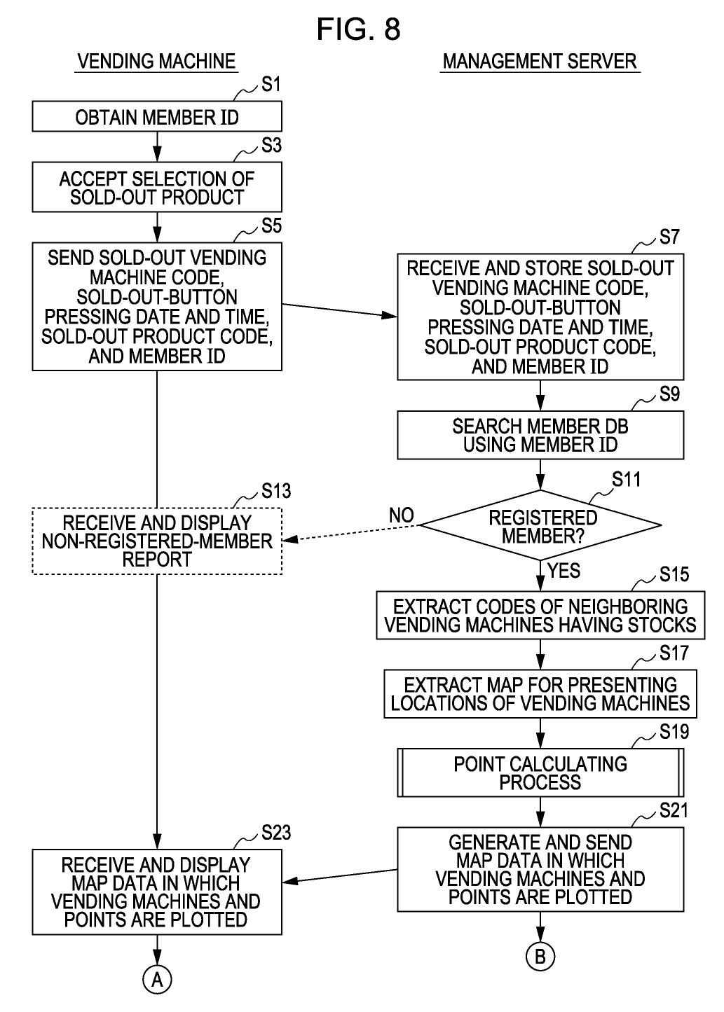

Next, flows of processes executed in the first embodiment will be described with reference to FIGS. 8 to 15.

A user inserts a member card into or places the member card against the ID reader 76 of a vending machine A so that a member ID recorded on the member card is read. The ID reader 76 of the vending machine A reads the member ID from the member card, and outputs the member ID to the controller 73 (operation S1). The controller 73 receives the member ID from the ID reader 76. Further, the user presses a purchase button corresponding to a product that the user selects to purchase at the vending machine A. It is assumed herein that the product that the user selects to purchase has been sold out and the sold-out status of the product is indicated, but the user still presses the purchase button corresponding to the product in this embodiment.

The basic sales function unit 74 of the vending machine A accepts selection of the sold-out product by the user pressing the purchase button, and outputs to the controller 73 a product code corresponding to the sold-out product(operation S3). The controller 73 receives the product code corresponding to the sold-out product from the basic sales function unit 74, and obtains the date and time when the purchase button corresponding to the sold-out product was pressed.

Then, the controller 73 of the vending machine A causes the communication unit 71 to send a sold-out message to the management server 5, the sold-out message including a sold-out vending machine code representing a code of the vending machine A, a sold-out button pressing date and time representing a date and time when the purchase button for the sold-out product was pressed, the product code corresponding to the sold-out product (a sold-out product code), and/or the member ID (operation S5).

The first sold-out processor 51 of the management server 5 receives the sold-out message including the sold-out vending machine code, the sold-out button pressing date and time, the sold-out product code, and/or the member ID, and stores the sold-out message in a storage device, such as a main memory (operation S7). Then, the first sold-out processor 51 searches the member DB 58 using, for example, the received member ID (operation S9), and checks whether the user is a registered member (operation S11) based upon the results of the search. That is, the first sold-out processor 51 checks whether the received member ID is registered in the member DB 58. If the received member ID is not registered in the member DB 58, the first sold-out processor 51 sends a non-registered-member report to the vending machine A. Upon receiving the non-registered-member report from the management server 5 via the communication unit 71, the controller 73 of the vending machine A displays a message on the display 72 indicating that the user is not registered in the member DB 58 (operation S13). The procedure is then exited.

On the other hand, if the received member ID is registered in the member DB 58, the first sold-out processor 51 extracts vending machine codes of vending machines having stocks of the product corresponding to the sold-out product code, for example, by searching the stock table 56 using the sold-out product code, and further extracts codes of vending machines located within a predetermined range of the sold-out vending machine (the vending machine A in this case) as neighboring vending machines by searching the vending machine DB 57 using the sold-out vending machine code and the extracted vending machine codes (operation S15). Further, the first sold-out processor 51 searches the map DB 60 on the basis of location data of the neighboring vending machines to extract a map indicating the locations of the sold-out vending machine and the neighboring vending machines corresponding to the extracted codes (operation S17).

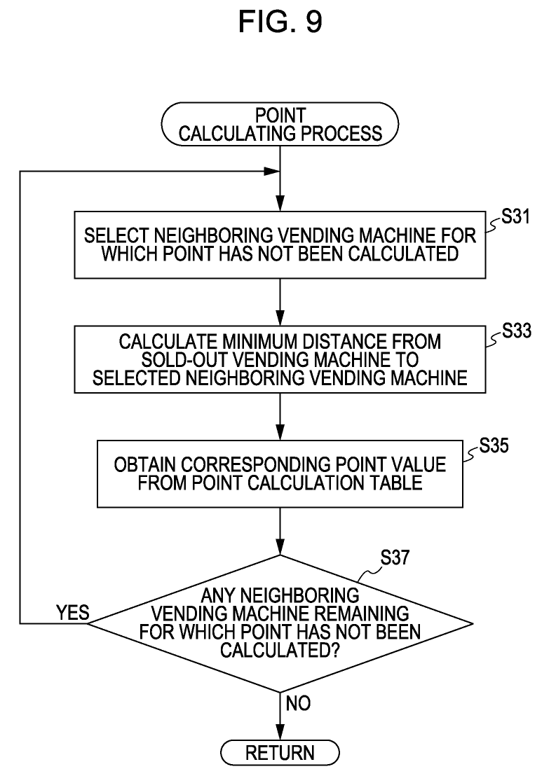

Further, the first sold-out processor 51 executes a point calculating process (operation S19). The point calculating process will be described with reference to FIG. 9.

Referring to FIG. 9, the first sold-out processor 51 selects a neighboring vending machine for which the point calculating process has not been executed (operation S31). Then, the first sold-out processor 51 calculates a minimum distance from the sold-out vending machine (the vending machine A) to the selected neighboring vending machine (a minimum distance along a route) (operation S33). The route calculating executed in operation S33 can be accomplished using known techniques, so that description of the route calculating will be omitted. The data associated with the route is stored for later use.

In operation S35, the first sold-out processor 51 obtains a point value corresponding to the minimum distance from the point calculation table 61. For example, when the minimum distance is 400 m, the first sold-out processor 51 obtains a corresponding point value of 30 points.

Then, when any neighboring vending machine for which the point calculating process has not yet been executed still exists (the “Yes” route is taken in operation S37), the process returns to operation S31. On the other hand, when the point calculating process has been completed for all the neighboring vending machines (the “No” route is taken in operation S37), the process returns to the calling process.

Referring again to FIG. 8, using the map data extracted in operation S17, the first sold-out processor 51 generates map data in which the neighboring vending machines and the sold-out vending machine are plotted with point values assigned to the individual neighboring vending machines, and sends the map data to the sold-out vending machine (the vending machine A) (operation S21).

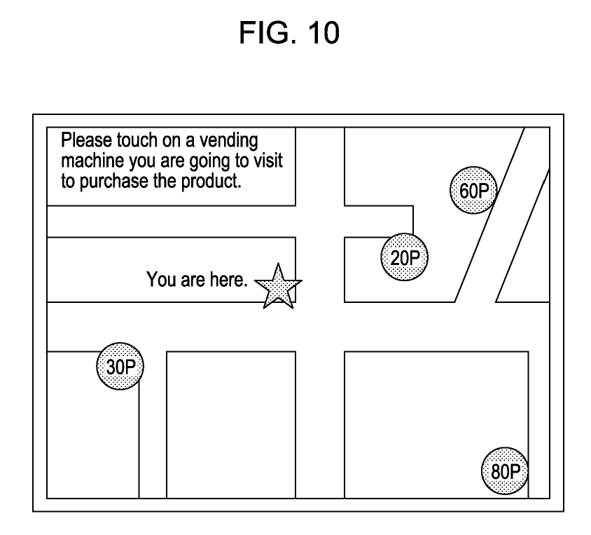

Then, the controller 73 of the vending machine A, i.e., the sold-out vending machine, receives, from the management server 5 via the communication unit 71, the map data in which the neighboring vending machines and the sold-out vending machine are plotted with point values assigned to the individual neighboring vending machines, and displays a map corresponding to the map data on the display 72 (operation S23). For example, a screen shown in FIG. 10 is displayed.

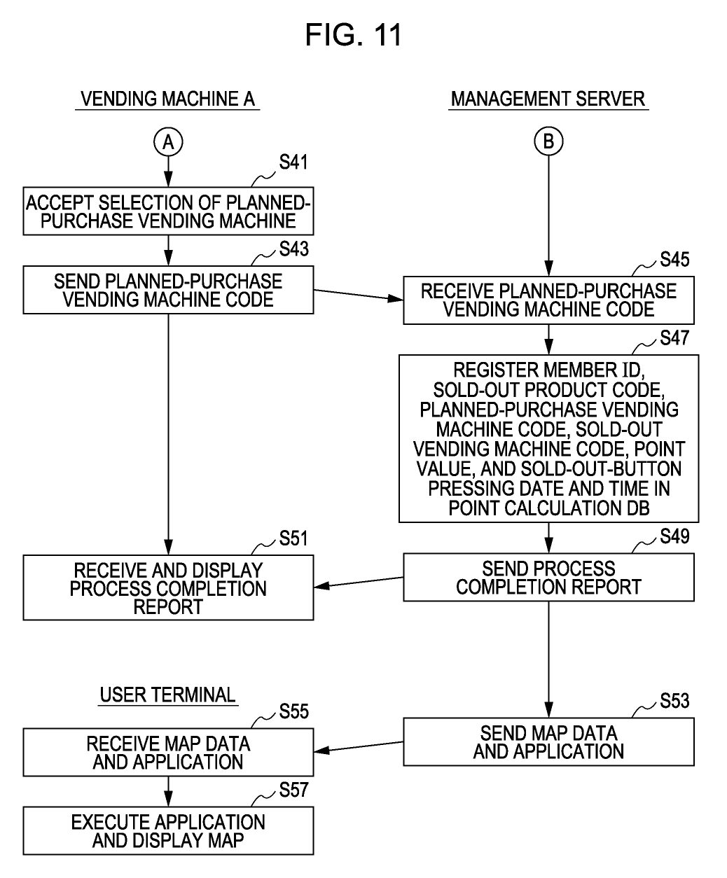

In the example shown in FIG. 10, the current position corresponds to the location of the sold-out vending machine, and the signs “20P”, “30P”, “60P”, and “80P” indicate the locations of the neighboring vending machines, with the numerals representing point values. The map data allows outputting of a vending machine code corresponding to a selected neighboring vending machine so that the vending machine code of the selected neighboring vending machine can be reported to the management server 5. Then, the procedure proceeds to a process shown in FIG. 11.

Referring now to FIG. 11, the user selects a vending machine where the user plans to purchase the product, and touches the position on the map displayed on display 72 and corresponding to the location of the vending machine. The display 72 of the vending machine A accepts selection of a planned-purchase vending machine (operation S41), and outputs a vending machine code of the planned-purchase vending machine (a planned-purchase vending machine code) to the controller 73. The controller 73 receives the planned-purchase vending machine code from the display 72, and causes the communication unit 71 to send the planned-purchase vending machine code to the management server 5 (operation S43).

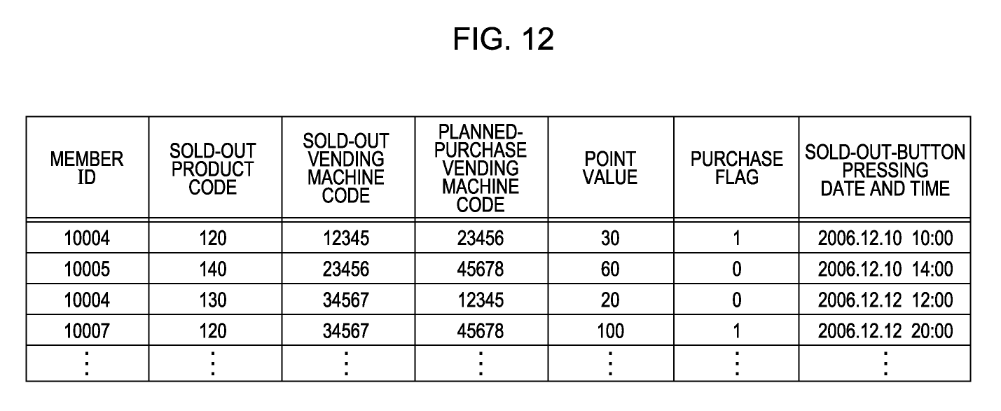

The first sold-out processor 51 of the management server 5 receives the planned-purchase vending machine code from the sold-out vending machine (vending machine A) (operation S45), and registers the planned-purchase vending machine code and a point value that is to be assigned when the product is purchased at the planned-purchase vending machine (the point value calculated in operation S19) in the point calculation DB 59 together with the member ID, the sold-out product code, the sold-out vending machine code, and the sold-out button pressing date and time received in operation S7 (operation S47). In the point calculation DB 59, for example, data shown in FIG. 12 is stored. In the example shown in FIG. 12, a member ID, a sold-out product code, a sold-out vending machine code, a planned-purchase vending machine code, a point value, a purchase flag (“0” in this case), and a sold-out button pressing date and time are registered. The value of the purchase flag is initially set to “0”, but the purchase flag is set to “1” when the corresponding sold-out product is purchased.

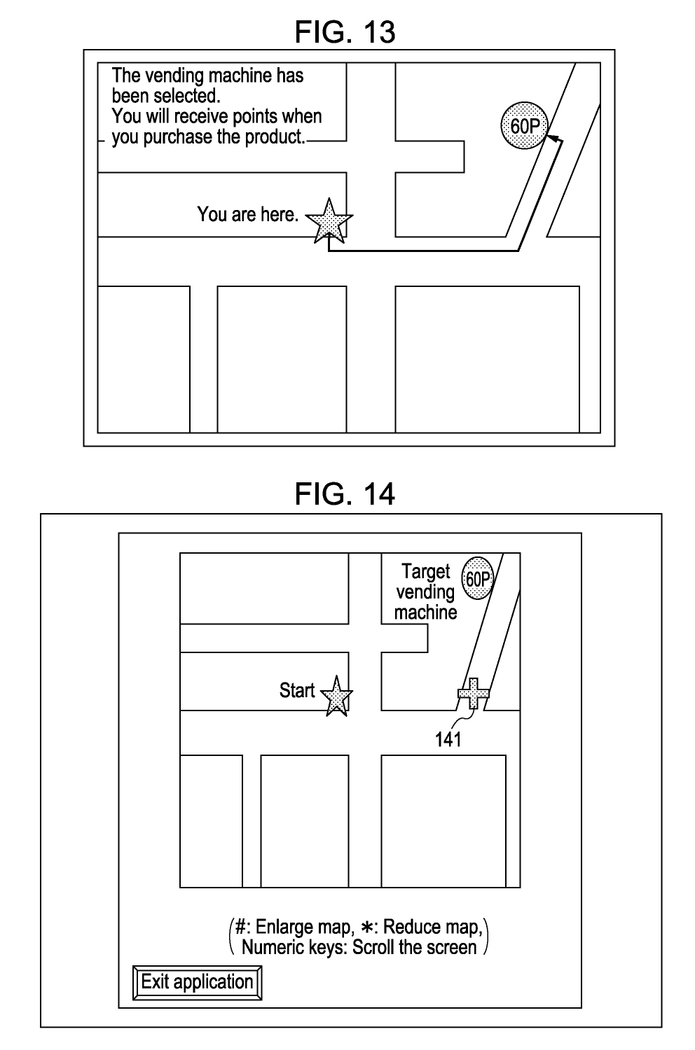

The first sold-out processor 51 generates a process completion report, and sends the process completion report to the sold-out vending machine (vending machine A) (operation S49). For example, the process completion report includes data of a route from the sold-out vending machine to the planned-purchase vending machine, and a message. The data of the route is identified, for example, in operation S19. The vending machine A receives the process completion report from the management server 5 via the communication unit 71, and displays the process completion report on the display 72 (operation S51). In the example shown in FIG. 13, a route from the current position (the sold-out vending machine) to the planned-purchase vending machine (the planned point-assignment vending machine indicated as “60P”) and a message such as “The vending machine has been selected. You will receive points when you purchase the product.” are displayed.

Further, the first sold-out processor 51 sends the map data and may also send an application program (e.g., an applet) that executes processing such as displaying the map data to a mail address identified on the basis of the member ID from the member DB 58 (operation S53). The user terminal A of the user receives the map data and the application program that executes processing such as displaying the map data from the management server 5 (operation S55), executes the application program, and displays a map corresponding to the map data on a display (operation S57). For example, a screen shown in FIG. 14 is displayed. In the example shown in FIG. 14, a map indicating the sold-out vending machine as a start point and indicating the planned-purchase vending machine as a target vending machine, and a button for exiting the application are displayed. Further, if the user terminal A has a GPS function, an icon 141 indicating the current position is displayed at a corresponding position on the map. If the user terminal does not have a GPS function, the icon 141 is not displayed. Thus, the user can readily go to the planned-purchase vending machine, where the user can get 60 points.

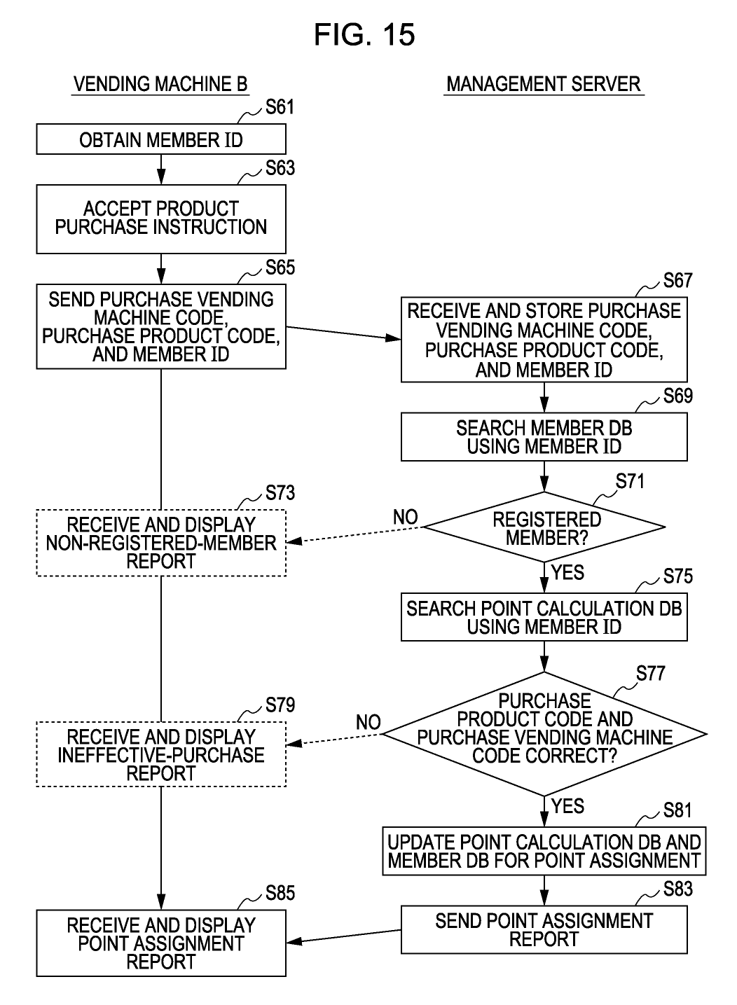

Next, a process for purchasing a sold-out product at a planned-purchase vending machine will be described with reference to FIG. 15. First, the user inserts the member card into or places the member card against the ID reader 76 of the planned-purchase vending machine (the vending machine B in this case) so that the member ID recorded on the member card is read. The ID reader 76 of the vending machine B reads the member ID from the member card, and outputs the member ID to the controller 73 (operation S61). The controller 73 receives the member ID from the ID reader 76. The user inserts a coin into the vending machine B and then presses a purchase button for the product that the user wishes to purchase. The basic sales function unit 74 of the vending machine B accepts a purchase instruction, outputs the product to an outlet slot from the stock, and outputs the product code of the purchased product (a purchase product code) to the controller 73 (operation S63).

The controller 73 causes the communication unit 71 to send a purchase report including the purchase vending machine code, the purchase product code, and the member ID to the management server 5 (operation S65). The arrival processor 52 of the management server 5 receives the purchase report including the purchase vending machine code, the purchase product code, and the member ID from the vending machine B, and stores the purchase report in a storage device, such as a main memory (operation S67). Then, the arrival processor 52 searches the member DB 58 using the received member ID (operation S69), and checks whether the user is a registered member (operation S71). That is, the arrival processor 52 checks whether the received member ID is registered in the member DB 58. If the received member ID is not registered in the member DB 58, the arrival processor 52 sends a non-registered-member report to the vending machine B. When the non-registered-member report is received from the management server 5 via the communication unit 71, the controller 73 of the vending machine B displays a message on the display 72 indicating that the user is not registered (operation S73). The procedure is then exited.

On the other hand, if the received member ID is registered in the member DB 58, the arrival processor 52 searches the point calculation DB 59 using the member ID, and reads a corresponding record (operation S75). Depending on circumstances, it is possible that no corresponding record registered in the point calculation DB 59 exists. The arrival processor 52 checks whether the purchase product code coincides with the sold-out product code and the purchase vending machine code coincides with the planned-purchase vending machine code (operation S77). When no corresponding record registered in the point calculation DB 59 exists, or when either one of these pairs of codes does not match, the arrival processor 52 sends an ineffective-purchase report indicating that points will not be assigned for the purchase to the vending machine B. The controller 73 of the vending machine B receives the ineffective-purchase report from the management server 5 via the communication unit 71, and displays a message saying, for example, “Points will not be assigned for this purchase.” on the display 72 (operation S79).

On the other hand, when the purchase product code coincides with the sold-out product code and the purchase vending machine code coincides with the planned-purchase vending machine code, the arrival processor 52 sets on the purchase flag of the record (i.e., sets the flag to “1”) in the point calculation DB 59, and adds a point value registered in the record to a point value in the record corresponding to the member ID in the member DB 58, thereby updating the point value in the record corresponding to the member ID in the member DB 58 (operation S81). Then, the arrival processor 52 sends a point assignment report to the vending machine B (operation S83).

The controller 73 of the vending machine B receives the point assignment report from the management server 5 via the communication unit 71, and displays a message saying, for example, “You received points.” on the display 72 (operation S85).

Thus, when the user purchases the sold-out product at the planned-purchase vending machine, points corresponding to the distance from the sold-out vending machine to the planned-purchase vending machine are assigned to the user. That is, it is possible to compensate for loss of potential sales by effectively using a sales network of vending machines.

In this embodiment, instead of sending an application program from the management server 5, it is possible to simply send only map data. It is also possible to send the map data in response to an access by a Web browser of the user terminal A.

As described above, in addition to simply providing information, when a user attempts to purchase a sold-out product, a sales site where the user plans to purchase the product and a point associated with the planned purchase are registered, and the point is assigned to the user when the user subsequently takes an action satisfying a predetermined condition. Thus, the user is motivated to purchase the sold-out product at the sales site specified for the planned purchase. This leads to sales of the sales-product using a sales network. As described above, sales of the sold-out product is supported by effectively using the sales network. The present embodiment can be applied to sales of various products as long as the products can be sold using sales networks. The terminal at the sales site may be, for example, a vending machine, or a stock query terminal or a point-of-sales (POS) terminal provided at a sales shop.

### Second Embodiment

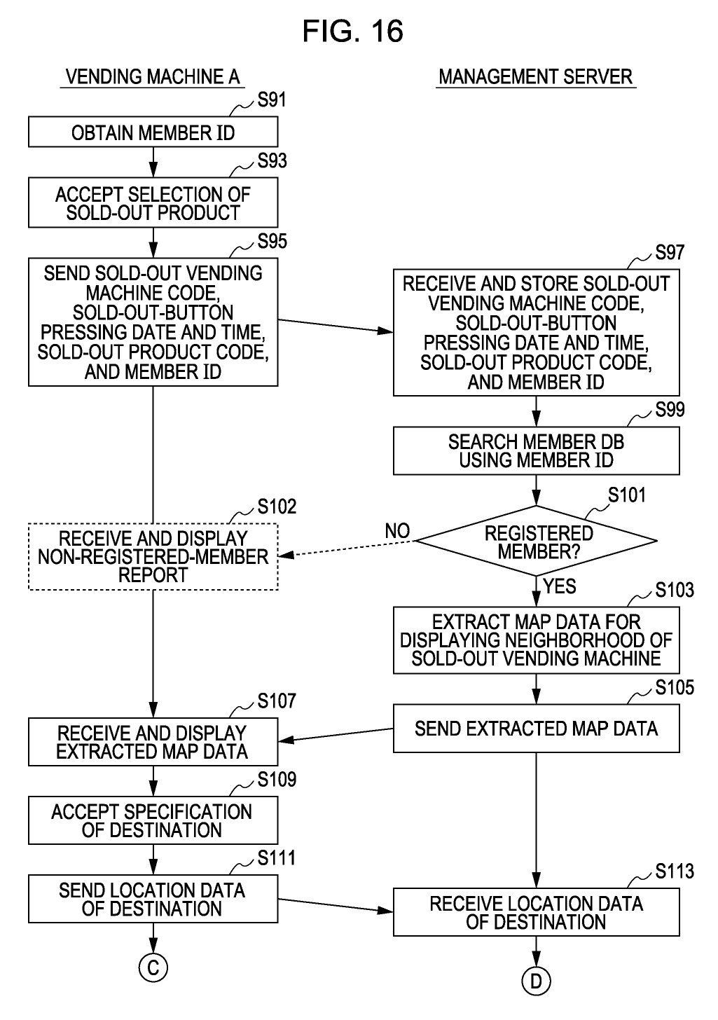

In the first embodiment described above, in some cases, the user can readily earn points by selecting a planned-purchase vending machine that is close to a destination of the user and remote from a sold-out vending machine. In order to avoid such a situation, in the second embodiment, a destination is set, and points are assigned on the basis of an extra distance of movement that occurs due to visiting a planned-purchase vending machine. Now, processes executed in the second embodiment will be described with reference to FIGS. 16 to 27.

Referring now to FIG. 16, a user inserts a member card into or places the member card against the ID reader 76 of a vending machine A so that a member ID recorded on the member card is read. The ID reader 76 of the vending machine A reads the member ID from the member card, and outputs the member ID to the controller 73 (operation S91). The controller 73 receives the member ID from the ID reader 76. Further, the user presses a button for purchasing a product that the user wishes to purchase at the vending machine A. It is assumed herein that the product that the user wishes to purchase has been sold out and the sold-out status of the product is indicated, but the user still presses the button for purchasing the product in this embodiment. The basic sales function unit 74 of the vending machine A accepts selection of the sold-out product by the user pressing the purchase button, and outputs a product code of the sold-out product (a sold-out product code) to the controller 73 (operation S93). The controller 73 receives the sold-out product code from the basic sales function unit 74, and obtains the date and time when the purchase button for the sold-out product was pressed.

Then, the controller 73 of the vending machine A causes the communication unit 71 to send a sold-out message to the management server 5, the sold-out message including a sold-out vending machine code representing a code of the vending machine A, a sold-out button pressing date and time representing a date and time when the purchase button for the sold-out product was pressed, the sold-out product code, and/or the member ID (operation S95). The second sold-out processor 53 of the management server 5 receives the sold-out message including the sold-out vending machine code, the sold-out button pressing date and time, the sold-out product code, and/or the member ID, and stores the sold-out message in a storage device, such as a main memory (operation S97). Then, the second sold-out processor 53 searches the member DB 58 using the received member ID (operation S99), and checks whether the user is a registered member (operation S101). That is, the second sold-out processor 53 checks whether the received member ID is registered in the member DB 58. If the received member ID is not registered in the member DB 58, the second sold-out processor 53 sends a non-registered-member report to the vending machine A. Upon receiving the non-registered-member report from the management server 5 via the communication unit 71, the controller 73 of the vending machine A displays a message on the display 72 indicating that the user is not registered (operation S102). The procedure is then exited.

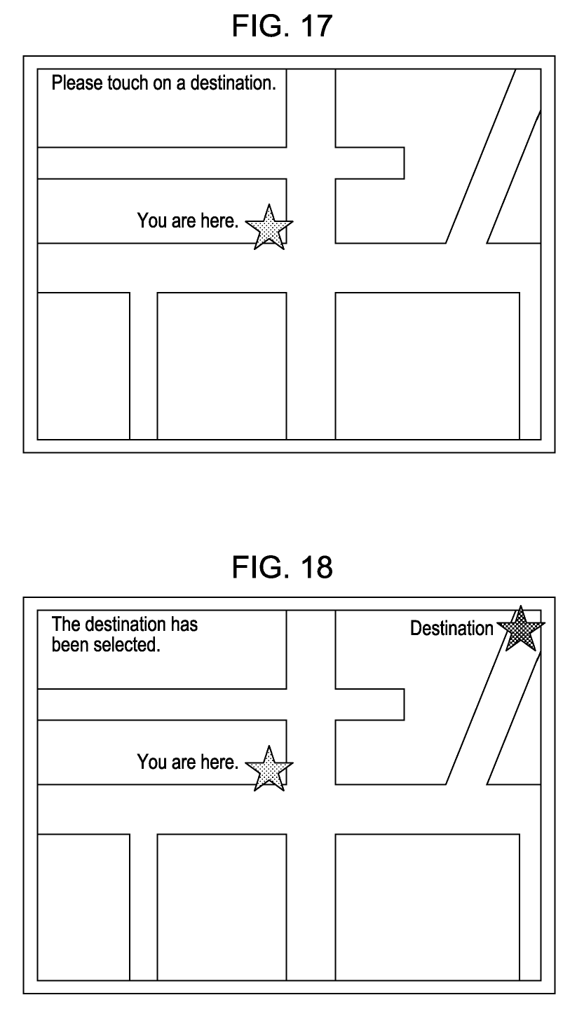

On the other hand, if the received member ID is registered in the member DB 58, the second sold-out processor 53 searches the vending machine DB 57 using the sold-out vending machine code to identify data of the location of the sold-out vending machine, and searches the map DB 60 using the location data of the sold-out vending machine to extract map data for displaying the neighborhood of the sold-out vending machine (operation S103). Then, the second sold-out processor 53 sends the extracted map data to the vending machine A as map data for specifying a destination (operation S105). The controller 73 of the vending machine A receives the map data from the management server 5 via the communication unit 71, and displays a map corresponding to the map data on the display 72 (operation S107). For example, a screen shown in FIG. 17 is displayed. In the example shown in FIG. 17, the location of the vending machine A, which is the sold-out vending machine, is displayed as a current position.

Then, the user identifies the location of a destination, and touches a position on the map displayed on display 72 and corresponding to the location of the destination. The display 72 of the vending machine A accepts specification of a destination (operation S109), and outputs information indicating the position of the destination on the screen to the controller 73. Further, the controller 73 causes the display 72 to indicate the destination. For example, a screen shown in FIG. 18 is displayed.

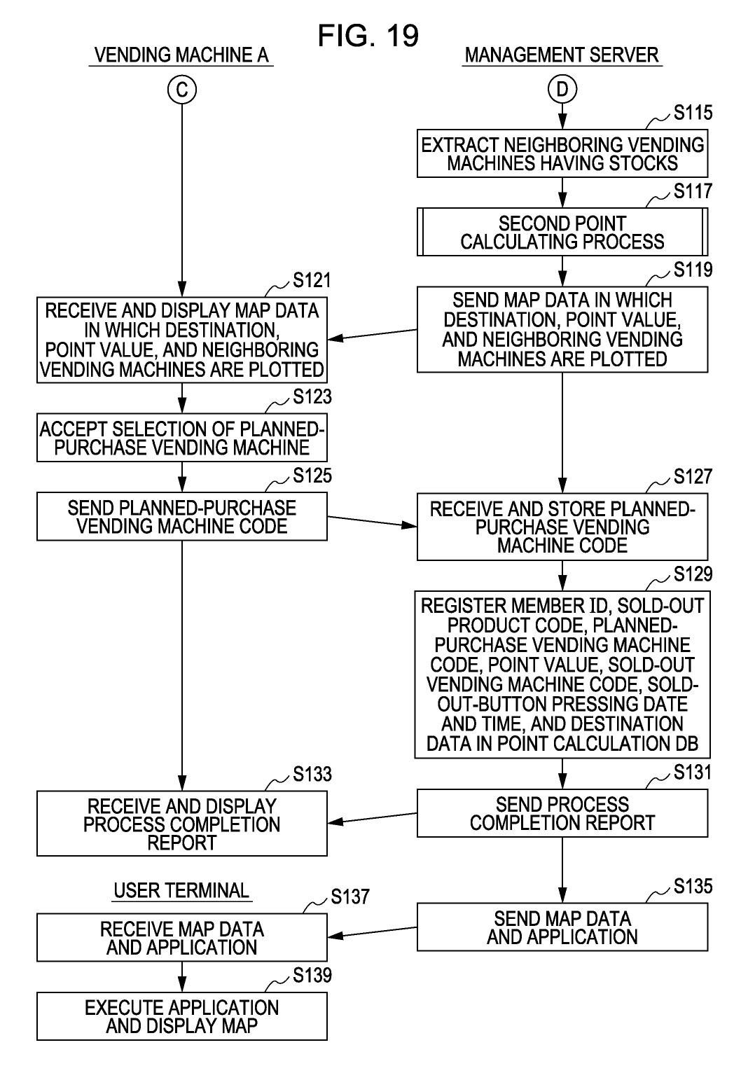

In the example shown in FIG. 18, the location of the vending machine A, which is the sold-out vending machine, is indicated as the current position, and a star mark is displayed at the position corresponding to the destination specified by the user. Further, the controller 73 receives information indicating the position on the screen corresponding to the destination from the display 72, converts the position information into actual location data of the destination, and causes the communication unit 71 to send the location data to the management server 5 (operation S111). The second sold-out processor 53 of the management server 5 receives the location data of the destination from the vending machine A, and stores the location data in a storage device, such as a main memory (operation S113). Then, the procedure proceeds to a process shown in FIG. 19. The conversion of the position information of the destination on the screen into the actual location data of the destination may be executed at the management server 5.

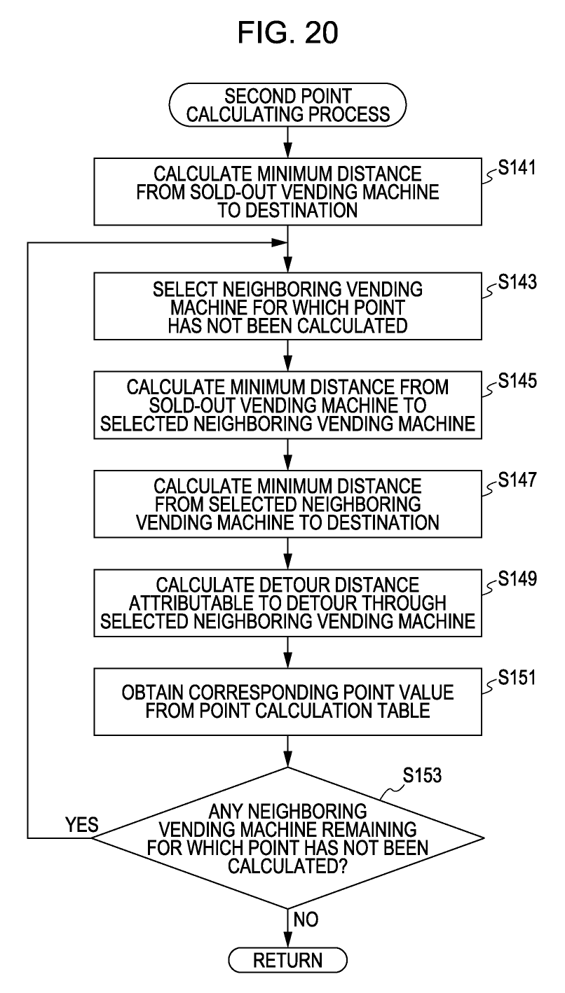

Referring now to FIG. 19, the second sold-out processor 53 extracts vending machine codes of vending machines having stocks of the product corresponding to the sold-out product code, for example, by searching the stock table 56 using the sold-out product code. The second sold-out processor 53 further extracts codes of vending machines located within a predetermined range of the sold-out vending machine (the vending machine A in this case) as neighboring vending machines by searching the vending machine DB 57 using the sold-out vending machine code and the extracted vending machine codes (operation S115). Further, the second sold-out processor 53 executes a second point calculating process (operation S117). The second point calculating process will be described with reference to FIG. 20.

Referring now to FIG. 20, the second sold-out processor 53 calculates a minimum distance (a minimum distance along a route) from the sold-out vending machine to the destination (hereinafter referred to as a first distance) (operation S141). The route calculating can be accomplished using known techniques, so that description of the route calculating will be omitted. The data of the route is stored for later use. Further, the second sold-out processor 53 selects a neighboring vending machine for which the second point calculating process has not yet been executed (operation S143). Then, the second sold-out processor 53 calculates a minimum distance (a minimum distance along a route) from the sold-out vending machine (the vending machine A) to the selected neighboring vending machine (hereinafter referred to as a second distance) (operation S145). The route data is stored for later use. Further, the second sold-out processor 53 calculates a minimum distance (a minimum distance along a route) from the selected neighboring vending machine to the destination (hereinafter referred to as a third distance) (operation S147). The route data is stored for later use.

Then, the second sold-out processor 53 adds together the second distance and the third distance, and subtracts the first distance from the result of the addition, thereby calculating a detour distance that occurs by detouring through the selected neighboring vending machine (operation S149). Then, the second sold-out processor 53 obtains a point value corresponding to the detour distance from the point calculation table 61 (operation S151). For example, when the detour distance is 600 m, the second sold-out processor 53 obtains a corresponding point value of 40 points. When any neighboring vending machine for which the second point calculating process has not yet been executed still exists (the “Yes” route is taken in operation S153), the process returns to operation S143. On the other hand, when the second point calculating process has been finished for all the neighboring vending machines (the “No” route is taken in operation S153), the process returns to the calling process.

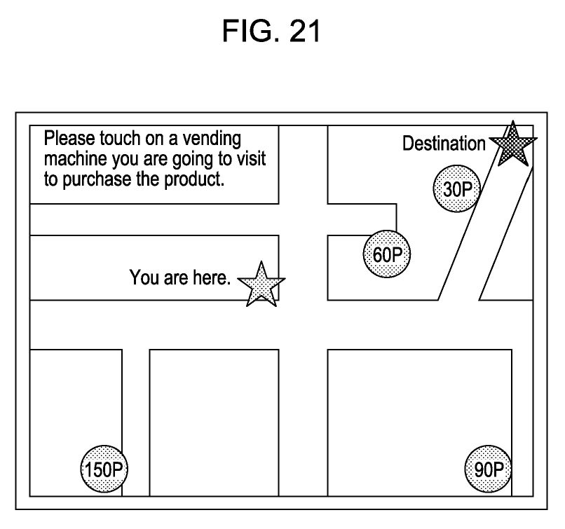

Referring again to FIG. 19, using the map data extracted in operation S103, the second sold-out processor 53 generates map data in which the neighboring vending machines and the sold-out vending machine are plotted with point values associated with the individual neighboring vending machines, and sends the map data to the sold-out vending machine (the vending machine A) (operation S119). Then, the controller 73 of the vending machine A, i.e., the sold-out vending machine, receives, from the management server via the communication unit 71, the map data in which the neighboring vending machines and the sold-out vending machine are plotted with point values associated with the individual neighboring vending machines, and displays a map corresponding to the map data on the display 72 (operation S121). For example, a screen shown in FIG. 21 is displayed on the display 72.

In the example shown in FIG. 21, “Destination” indicates the destination specified by the user, and “You are here.” indicates the location of the sold-out vending machine. The signs “30P”, “60P”, “90P”, and “150P” indicate the locations of the neighboring vending machines, with the numerals representing point values. The locations of the neighboring vending machines are associated with vending machine codes so that the vending machine code of a selected neighboring vending machine can be reported by outputting the vending machine code.

The user selects a vending machine where the user plans to purchase the product, and touches the position on the map displayed on display 72 and corresponding to the location of the vending machine. The display 72 of the vending machine A accepts selection of a planned-purchase vending machine (operation S123), and outputs a vending machine code of the planned-purchase vending machine (a planned-purchase vending machine code) to the controller 73. The controller 73 receives the planned-purchase vending machine code from the display 72, and causes the communication unit 71 to send the planned-purchase vending machine code to the management server 5 (operation S125).

The second sold-out processor 53 of the management server 5 receives the planned-purchase vending machine code from the sold-out vending machine (vending machine A) (operation S127), and registers the planned-purchase vending machine code and a point value that is to be assigned when the product is purchased at the planned-purchase vending machine (the point value calculated in operation S117) in the point calculation DB 59 together with the member ID, the sold-out product code, the sold-out vending machine code, and/or the sold-out button pressing date and time received in operation S97 and/or the destination data received in operation S113 (operation S129).

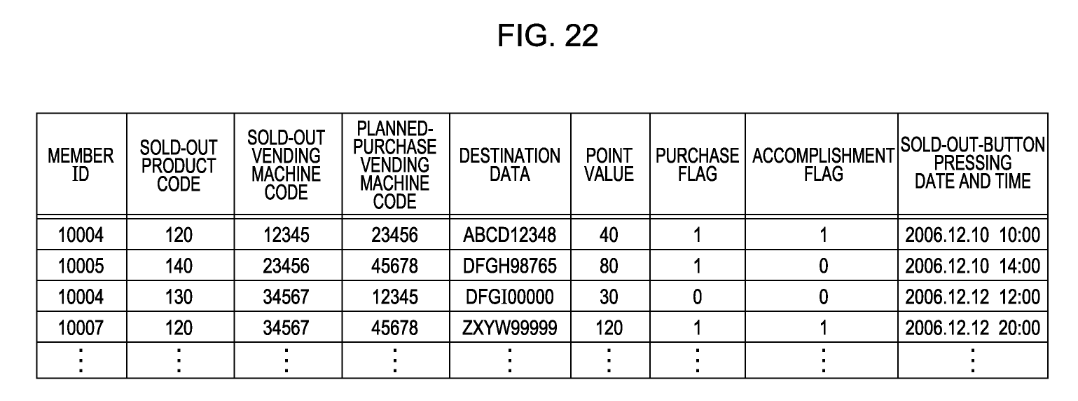

In the point calculation DB 59, for example, data shown in FIG. 22 is stored. In the example shown in FIG. 22, a member ID, a sold-out product code, a sold-out vending machine code, a planned-purchase vending machine code, destination data, a point value, a purchase flag (“0” in this case), an accomplishment flag (“0” in this case), and a sold-out button pressing date and time are registered. The value of the purchase flag is initially set to “0”, but the purchase flag is set to “1” when the corresponding sold-out product is purchased. Similarly, the value of the accomplishment flag is initially set to “0”, but the accomplishment flag is set to “1” when the user arrives at the destination.

The second sold-out processor 53 generates a process completion report, and sends the process completion report to the sold-out vending machine (vending machine A) (operation S131). For example, the process completion report includes data of a route from the sold-out vending machine to the planned-purchase vending machine, and a message. The data of the route is identified, for example, in operation S117.

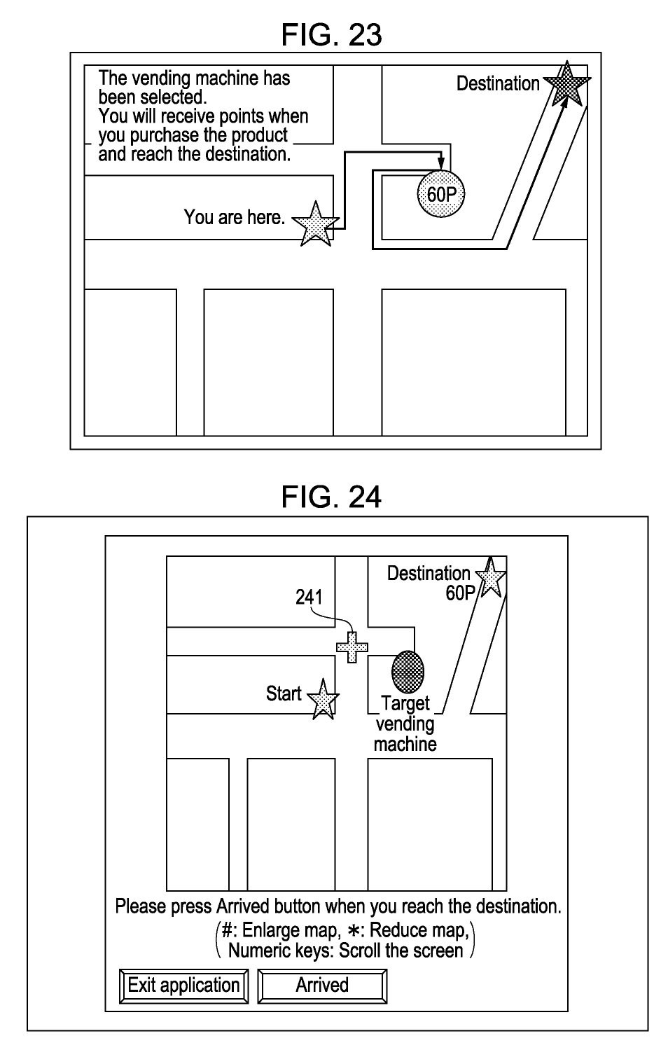

The vending machine A receives the process completion report from the management server 5 via the communication unit 71, and displays the process completion report on the display 72 (operation S133). In the example shown in FIG. 23, a route from the current position (the sold-out vending machine) to the planned-purchase vending machine (the planned point-assignment vending machine indicated as “60P”), a route from the planned-purchase vending machine to the destination, and a message saying “The vending machine has been selected. You will receive points when you purchase the product and reach the destination.” are displayed on the display 72.

Further, the second sold-out processor 53 sends the map data and may also send an application program (e.g., an applet) that executes processing such as displaying the map data to a mail address identified on the basis of the member ID from the member DB 58 (operation S135). The user terminal A of the user receives the map data and the application program that executes processing such as displaying the map data from the management server 5 (operation S137), executes the application program, and displays a map corresponding to the map data on a display (operation S139). For example, a screen shown in FIG. 24 is displayed. In the example shown in FIG. 24, a map indicating the sold-out vending machine as a start point, indicating the planned-purchase vending machine as a target vending machine, and indicating the location of the specified destination, a button for exiting the application, and an arrival button for obtaining data of a current position by the GPS function and sending the data to the management server 5 when the user arrives at the destination are displayed. An icon 241 indicating the current position is displayed at a corresponding position on the map. Thus, the user can readily go to the planned-purchase vending machine and the destination, whereby the user can get 60 points.

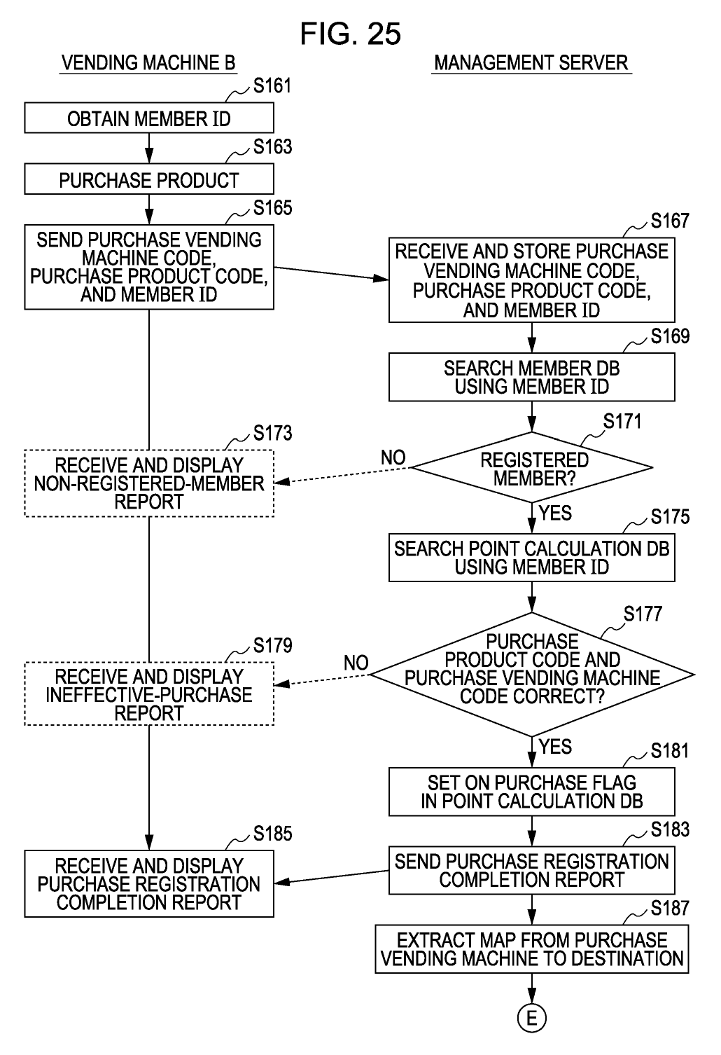

Next, a process that is executed when the user arrives at the planned-purchase vending machine will be described with reference to FIGS. 25 to 27. First, the user inserts the member card into or places the member card against the ID reader 76 of the planned-purchase vending machine (the vending machine B in this case) so that the member ID recorded on the member card is read. The ID reader 76 of the vending machine B reads the member ID from the member card, and outputs the member ID to the controller 73 (operation S161). The controller 73 receives the member ID from the ID reader 76. The user inserts a coin into the vending machine B and then presses a purchase button for the product that the user wishes to purchase. The basic sales function unit 74 of the vending machine B accepts a purchase instruction, outputs the product to an outlet slot from the stock, and outputs the product code of the purchased product (a purchase product code) to the controller 73 (operation S163).

The controller 73 causes the communication unit 71 to send a purchase report including the purchase vending machine code, the purchase product code, and the member ID to the management server 5 (operation S165). The vending-machine arrival processor 54 of the management server 5 receives the purchase report including the purchase vending machine code, the purchase product code, and the member ID from the vending machine B, and stores the purchase report in a storage device, such as a main memory (operation S167). Then, the vending-machine arrival processor 54 searches the member DB 58 using the received member ID (operation S169), and checks whether the user is a registered member (operation S171). That is, the vending-machine arrival processor 54 checks whether the received member ID is registered in the member DB 58. If the received member ID is not registered in the member DB 58, the vending-machine arrival processor 54 sends a non-registered-member report to the vending machine B. When the non-registered-member report is received from the management server 5 via the communication unit 71, the controller 73 of the vending machine B displays a message on the display 72 indicating that the user is not registered (operation S173). The procedure is then exited. The point calculation DB 59 may be searched at this time.

On the other hand, if the received member ID is registered in the member DB 58, the vending-machine arrival processor 54 searches the point calculation DB 59 using the member ID, and reads a corresponding record (operation S175). Depending on circumstances, it is possible that no corresponding record registered in the point calculation DB 59 exists. The vending-machine arrival processor 54 checks whether the purchase product code coincides with the sold-out product code and the purchase vending machine code coincides with the planned-purchase vending machine code (operation S177). When no corresponding record registered in the point calculation DB 59 exists, or when either one of these pairs of codes does not match, the vending-machine arrival processor 54 sends an ineffective-purchase report indicating that points will not be assigned for the purchase to the vending machine B. The controller 73 of the vending machine B receives the ineffective-purchase report from the management server 5 via the communication unit 71, and displays a message saying, for example, “Points will not be assigned for this purchase.” on the display 72 (operation S179).

On the other hand, when the purchase product code coincides with the sold-out product code and the purchase vending machine code coincides with the planned-purchase vending machine code, the vending-machine arrival processor 54 sets on the purchase flag of the record (i.e., sets the flag to “1”) in the point calculation DB 59 (operation S181). Then, the vending-machine arrival processor 54 sends a purchase-registration completion report to the vending machine B (operation S183). The controller 73 of the vending machine B receives the purchase-registration completion report from the management server 5 via the communication unit 71, and displays a message saying, for example, “The purchase has been registered. You will receive points when you reach the destination.” on the display 72 (operation S185).

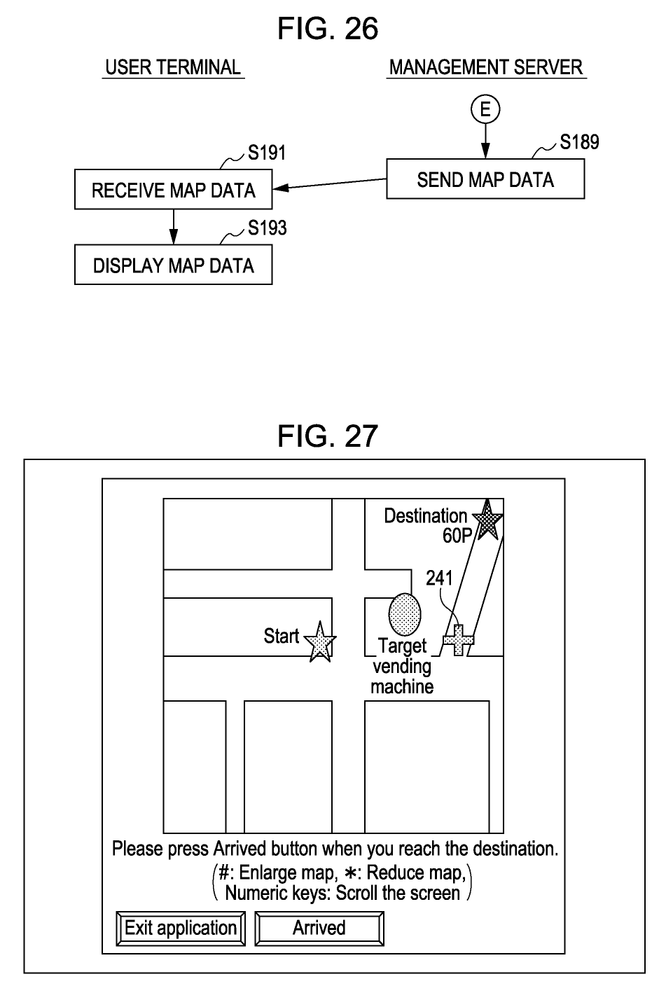

Further, using the record extracted in operation S175, the vending-machine arrival processor 54 extracts map data from the purchase vending machine to the destination from the map DB 60 (operation S187). The procedure proceeds to a process shown in FIG. 26 via a terminal E.

The vending-machine arrival processor 54 sends the map data extracted in operation S187 to the user terminal A (operation S189). An application program of the user terminal A receives the map data from the management server 5 (operation S191), and displays a map corresponding to the map data on a display (operation S193). For example, a screen shown in FIG. 27 is displayed. In the example shown in FIG. 27, a map indicating the sold-out vending machine as a start point, indicating the planned-purchase vending machine as a target vending machine, and indicating the location of the specified destination, a button for exiting the application, and an arrival button for obtaining data of a current position by the GPS function and sending the data to the management server 5 when the user arrives at the destination are displayed. An icon 241 indicating the current position obtained by the GPS function is displayed at a corresponding position on the map. Thus, the user can readily go to the destination from the purchase vending machine, whereby the user can get points in the end.

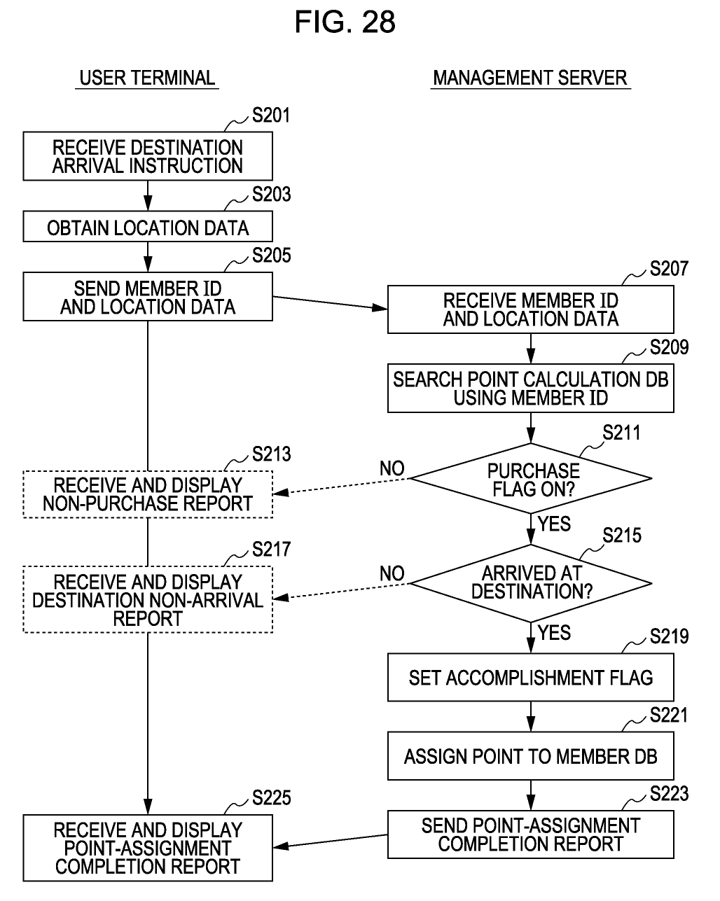

Next, a flow of a process that is executed when the user arrives at the destination will be described with reference to FIG. 28. When the user arrives at the destination, the user clicks on an arrival button displayed on the screen of the user terminal A. The application program of the user terminal A accepts a destination arrival instruction from the user (operation S201), and obtains location data by the GPS function (operation S203). Then, the application program sends the member ID and the location data to the management server 5 (operation S205). The member ID may be obtained, for example, through input by the user. Alternatively, when the user terminal A is a cellular phone having an IC-card function, the member ID may be obtained using the IC-card function.

The destination arrival processor 55 of the management server 5 receives the member ID and the location data from the user terminal A (operation S207). Then, the destination arrival processor 55 searches the point calculation DB 59 using the member ID to extract a corresponding record (operation S209). When no corresponding record exists, an error is assumed. Then, the destination arrival processor 55 checks whether the purchase flag in the extracted record is ON (operation S211). If the purchase flag is still OFF, the destination arrival processor 55 sends a non-purchase report and sends the non-purchase report to the user terminal A. The application program of the user terminal A receives the non-purchase report from the management server 5, and displays the non-purchase report on a display (operation S213). For example, the application program displays a message saying, “You have not purchased the product yet.”

On the other hand, when the purchase flag is ON, the destination arrival processor 55 checks whether it can be assumed that the destination data included in the extracted record coincides with the received location data, i.e., whether it can be assumed that the user has arrived at the destination (operation S215). When it cannot be assumed that the destination data coincides with the received location data, the destination arrival processor 55 generates a destination non-arrival report, and sends the destination non-arrival report to the user terminal A. The application program of the user terminal A receives the destination non-arrival report from the management server 5, and displays the destination non-arrival report on a display (operation S217). For example, the application program displays a message saying, “You have not arrived at the destination.”

On the other hand, when it can be assumed that the user has arrived at the destination, the destination arrival processor 55 sets the accomplishment flag of the corresponding record in the point calculation DB 59 (operation S219). Further, the destination arrival processor 55 assigns points in the member DB 58 (operation S221). More specifically, the destination arrival processor 55 adds the point value included in the corresponding record in the point calculation DB 59 to a point value corresponding to the member ID in the member DB 58, and registers the increased point value in association with the member ID in the member DB 58. Then, the destination arrival processor 55 sends a point-assignment completion report to the user terminal A (operation S223). The application program of the user terminal A receives the point-assignment completion report from the management server 5, and displays the point-assignment completion report on a display (operation S225). For example, the application program displays a message saying, “You have received points”. Then, the user clicks on the exit button on the screen to exit the application program.

In this manner, when a product has been sold out at a vending machine, the user can purchase the product at another vending machine, and earn points when the user arrives at a destination. A business entity can assign points to the user as a reward for purchasing the product by effectively using a sales network, while avoiding cases where the user earns points easily by visiting a vending machine that happens to be located in the vicinity of a destination.

Although embodiments have been described above, the claims are not limited to the embodiments. For example, although vending machines are described as an example of sales network, the present embodiments can be applied to a sales network of real stores. For example, bookstores often have stock searching terminals and also POS terminals. For example, when it is found by a stock searching terminal at a first bookstore that no stock is available at the first bookstore, a process similar to the process executed by the sold-out vending machine is executed. Further, at the time of payment at a POS terminal at a second bookstore having a stock, a process similar to the process executed by the purchase vending machine is executed. This achieves advantages similar to the advantages achieved in the case of vending machines. Without limitation to bookstores, the present embodiments can be applied to stores of other products having a sales network.

Further, the functional block diagram of the management server 5 shown in FIG. 1 is only an example, and the actual configuration of program modules does not necessarily coincide with the functional block diagram.

Further, the operations in the flows of processes described above may be executed in different orders or in parallel as long as similar advantages can be achieved.

It is possible to assign different functions to the vending machines and the management server 5. For example, the vending machines may maintain a map DB and a point calculation table so that the vending machines can search for routes and calculate point values. Also, the management server 5 may be implemented by a single computer or a plurality of computers.

Further, the procedure according to the first embodiment may be executed when it is not possible to input a destination in the scheme according to the second embodiment.

Further, regarding the records in the point calculation DB 59, it is possible to set an effective period of a predetermined length from a sold-out-button pressing date and time, so that it is not allowed to register a plurality of records for a member ID within the effective period until point assignment is completed. This serves to prevent registration of data for illegitimate purposes. Further, records for which the effective period has expired are discarded.

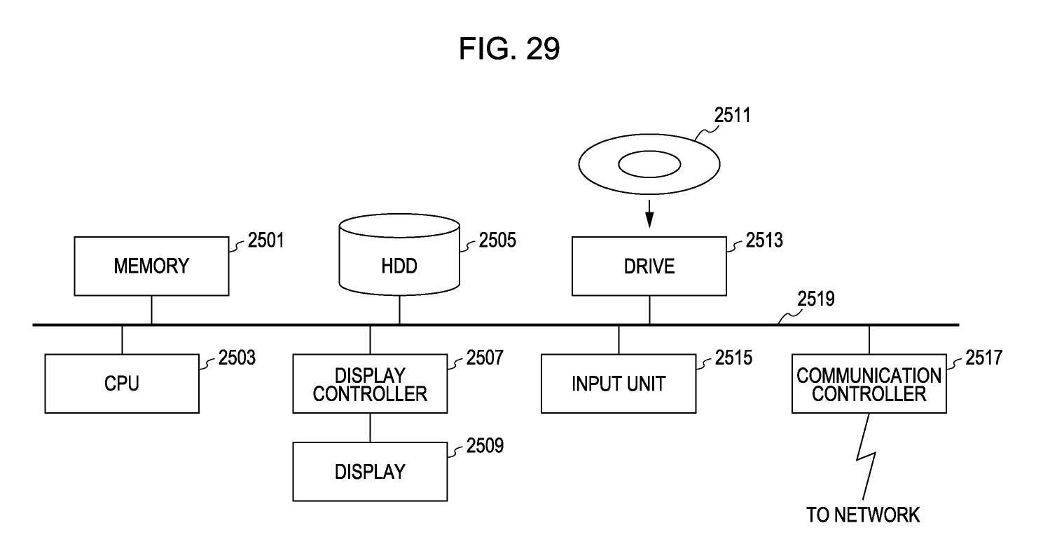

The management server 5 is, for example, a computer. As shown in FIG. 29, the computer includes a memory 2501 (a storage device), a central processing unit (CPU) 2503 (a processing unit), a hard disk drive (HDD) 2505, a display controller 2507 connected to a display 2509, a drive 2513 for a removable disk 2511, an input unit 2515, and a communication controller 2517 for connecting to a network. These components are connected to each other via a bus 2519. An operating system (OS) and application programs including a Web browser are stored in the HDD 2505, and are loaded from the HDD 2505 into the memory 2501 when executed by the CPU 2503. The CPU 2503 controls the display controller 2507, the communication controller 2517, and the drive 2513 as may be needed to execute operations. Data that occurs in the course of processing is stored in the memory 2501, and is stored in the HDD 2505 as may be needed. The computer configured as described above achieves the various functions described earlier through effective cooperation of the hardware such as the CPU 2503 and the memory 2501, the OS, and application programs.

In addition to the above-described embodiments, it will be appreciated that alternate embodiments are available.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A sales-assistance processing method that is executed by a computer, the sales-assistance processing method comprising:
receiving a sales-site query request and storing the sales-site query request in a storage device, the sales-site query request including a product code of a sold-out product, a code of a sales site where the sold-out product became sold out, and member identification information, and the sales-site query request being transmitted from a terminal at the sales site where the sold-out product became sold out;
searching a stock-data storage unit storing codes of sales sites and product stock data using the product code of the sold-out product, and searching a sales-site-data storage unit storing codes and location data of sales sites using the product code of the sold-out product, thereby extracting location data and codes of sales sites located within a predetermined range of the sales site where the sold-out product became sold out and having stocks of the sold-out product;
extracting map data indicating locations of the sales sites corresponding to the extracted codes from a map-data storage unit storing map data, updating the map data so that the map data indicates the locations of the sales sites corresponding to the extracted codes and includes the extracted codes of the sales sites, and sending the updated map data to the terminal at the sales site where the sold-out product became sold out;
receiving the code of a sales site selected from the sales sites corresponding to the extracted codes by a user from the terminal at the sales site where the sold-out product became sold out; and
storing the member identification information, the code of the sales site selected by the user, the product code of the sold-out product, and a point value in a point-calculation-data storage unit.

2. The sales-assistance processing method according to claim 1, further comprising:
calculating the point value on the basis of a distance of a route from the sales site where the sold-out product became sold out to the sales site selected by the user.

3. The sales-assistance processing method according to claim 1, further comprising:
when a sales report including a product code of a sales product, a code of a sales site of the sales product, and member identification information is received from a terminal at the sales site of the sales product, checking whether the sales report matches data stored in the point-calculation-data storage unit; and
when the sales report matches the data, increasing a point value of the user identified on the basis of the member identification information by the point value stored in the point-calculation-data storage unit and storing the increased point value in association with the member identification information in a member-data storage unit.

4. The sales-assistance processing method according to claim 1, further comprising:
receiving data of a destination of the user from the terminal at the sales site where the sold-out product became sold out, and storing the data in association with the member identification of the user in the point-calculation-data storage unit; and
calculating the point value according to relationship between a distance of a route from the sales site where the sold-out product became sold out to the destination of the user and a distance of a route from the sales site where the sold-out product became sold out to the destination of the user via the sales site selected by the user.

5. The sales-assistance processing method according to claim 1, further comprising:
receiving data of a destination of the user from the terminal at the sales site where the sold-out product became sold out, and storing the data in association with the member identification information of the user in the point-calculation-data storage unit;
when a sales report including a product code of a sales product, a code of a sales site of the sales product, and member identification information is received from a terminal at the sales site of the sales product, checking whether the sales report matches data stored in the point-calculation data storage unit;
when the sales report matches the data, registering a sales completion status in association with the member identification information in the point-calculation-data storage unit;
when a destination-arrival report including location data is received from a terminal of the user, searching the point-calculation-data storage unit using the member identification information of the user, and checking whether the location data received matches the data of the destination and whether the sales completion status has been registered; and
when the location data matches the destination data and the sales completion status has been registered, increasing a point value of the user identified on the basis of the member identification information by the point value stored in the point-calculation-data storage unit, and storing the increased point value in association with the member identification information in a member-data storage unit.

6. The sales-assistance processing method according to any one of claims 1 to 5, wherein the terminal at the sales site is a vending machine.

7. At least one computer-readable medium storing a sales-assistance processing program for causing a computer to execute the operations of:
receiving a sales-site query request and storing the sales-site query request in a storage device, the sales-site query request including a product code of a sold-out product, a code of a sales site where the sold-out product became sold out, and member identification information, and the sales-site query request being transmitted from a terminal at the sales site where the sold-out product became sold out;
searching a stock-data storage unit storing codes of sales sites and product stock data using the product code of the sold-out product, and searching a sales-site-data storage unit storing codes and location data of sales sites using the product code of the sold-out product, thereby extracting location data and codes of sales sites located within a predetermined range of the sales site where the sold-out product became sold out and having stocks of the sold-out product;
extracting map data for indicating locations of the sales sites corresponding to the extracted codes from a map-data storage unit storing map data, updating the map data so that the map data indicates the locations of the sales sites corresponding to the extracted codes and includes the extracted codes of the sales sites, and sending the updated map data to the terminal at the sales site where the sold-out product became sold out;
receiving the code of a sales site selected from the sales sites corresponding to the extracted codes by a user from the terminal at the sales site where the sold-out product became sold out; and
storing the member identification information, the code of the sales site selected by the user, the product code of the sold-out product, and a point value in a point-calculation-data storage unit.

8. A sales-assistance processing apparatus comprising:
means for receiving a sales-site query request and storing the sales-site query request in a storage device, the sales-site query request including a product code of a sold-out product, a code of a sales site where the sold-out product became sold out, and member identification information, and the sales-site query request being transmitted from a terminal at the sales site where the sold-out product became sold out;
means for searching a stock-data storage unit storing codes of sales sites and product stock data using the product code of the sold-out product, and searching a sales-site-data storage unit storing codes and location data of sales sites using the product code of the sold-out product, thereby extracting location data and codes of sales sites located within a predetermined range of the sales site where the sold-out product became sold out and having stocks of the sold-out product;
means for extracting map data for indicating locations of the sales sites corresponding to the extracted codes from a map-data storage unit storing map data, updating the map data so that the map data indicates the locations of the sales sites corresponding to the extracted codes and includes the extracted codes of the sales sites, and sending the updated map data to the terminal at the sales site where the sold-out product became sold out;
means for receiving the code of a sales site selected from the sales sites corresponding to the extracted codes by a user from the terminal at the sales site where the sold-out product became sold out; and
means for storing the member identification information, the code of the sales site selected by the user, the product code of the sold-out product, and a point value in a point-calculation-data storage unit.

9. A method of a computer system, comprising:
transmitting a message between a first sales site and a server a message indicating that a product is unavailable at the first sales site; and
transmitting between the server and the first sales site, a location of a second sales site at which the product is available, and displaying the location at the first sales site by the first sales site.

10. The method of claim 9, wherein the message includes identifying information of a user, the method further comprising:
determining whether the user is registered with the server based upon the identifying information.

11. The method of claim 10, further comprising:
allocating points to the user based upon a location of the first sales site and the location of the second sales site, if the user is registered with the server.

12. The method of claim 10, further comprising:
transmitting, to a terminal of the user, the location of the second sales site, if the user is registered with the server.

13. At least one computer-readable medium storing a program causing a computer to execute the operations comprising:
transmitting a message between a first sales site and a server a message indicating that a product is unavailable at the first sales site; and
transmitting between the server and the first sales site, a location of a second sales site at which the product is available, and displaying the location at the first sales site by the first sales site.

14. The at least one computer-readable medium of claim 13, wherein the message includes identifying information of a user, the method further comprising:
determining whether the user is registered with the server based upon the identifying information.

15. The at least one computer-readable medium of claim 13, further comprising:
allocating points to the user based upon a location of the first sales site and the location of the second sales site, if the user is registered with the server.

16. The at least one computer-readable medium of claim 13, further comprising:
transmitting, to a terminal of the user, the location of the second sales site, if the user is registered with the server.

17. A computer system comprising:
a first sales site terminal;
a second sales site terminal; and
a server in communication with the first sales site terminal and the second sales site terminal, wherein the computer system transmitting a first message between the first sales site terminal and the server indicating that a product is unavailable at the first sales site terminal, determining a location of the second sales site terminal at which the product is available, and transmitting a second message between the first sales site terminal and the server indicating the location of the second sales site terminal.

18. The computer system of claim 17, wherein the first message includes identifying information of a user, wherein the computer system determining whether the user is registered with the server based upon the identifying information.

19. The computer system claim 18, wherein the computer system allocating points to the user based upon a location of the first sales site and the location of the second sales site, if the user is registered with the server.

20. The computer system of claim 18, wherein the computer system transmitting, to a terminal of the user, the location of the second sales site, if the user is registered with the server.
